(19) United States
(12) Patent Application Publication
(10) Pub. No.: US 2024/0333886 A1
(43) Pub. Date: Oct. 3, 2024

(54) ACTUATING MODULE AND PROJECTION DEVICE

(71) Applicant: Coretronic Corporation, Hsin-Chu (TW)

(72) Inventor: Chang-Hsuan Chen, Hsin-Chu (TW)

(73) Assignee: Coretronic Corporation, Hsin-Chu (TW)

(21) Appl. No.: 18/613,119

(22) Filed: Mar. 22, 2024

(30) Foreign Application Priority Data
Mar. 28, 2023 (CN) 202310309546.4
Mar. 12, 2024 (CN) 202410277295.0

(51) Int. Cl. H04N 9/31

(52) U.S. Cl. CPC H04N 9/3155; H04N 9/3152

(57) ABSTRACT

An actuating module includes a frame, a light-transmitting element, at least one actuator, and a light shielding member. The light-transmitting element is disposed on the frame. A part of at least one actuator is connected to the frame for driving the frame to vibrate. The light shielding member is configured to overlap at least a part of an incident surface, a light emitting surface or one of a combination thereof of the light-transmitting element for reflecting and/or absorbing a light beam. The actuating module may be configured in a projection device, and the light shielding member may prevent an ineffective light beam from entering a projection lens, so as to reduce the light leakage caused by the ineffective light beam entering the projection lens, thereby improving the display effect in an off state.

### CROSS-REFERENCE TO RELATED APPLICATION

The application claims the priority benefit of China application serial no. 202310309546.4, filed on Mar. 28, 2023, and China application serial no. 202410277295.0, filed on Mar. 12, 2024. The entirety of the above-mentioned patent applications are hereby incorporated by reference herein and made a part of the specification.

### BACKGROUND

### Technical Field

The disclosure relates to an optical element and an electronic device, and in particular, to an actuating module and a projection device.

### Description of Related Art

The projection device is a display device for generating a large-scale image, and the projection device has been continuously improved with the evolution and innovation of technology. The imaging principle applied to the projection device is to convert the illumination light beam generated by the illumination system into an image light beam through the light valve, and then the image light beam is projected to the projection target (such as a screen or a wall) through the projection lens to form a projection image. In the 4K projection device, an actuator is added between the total reflection prism and the projection lens to increase the resolution of the projection image by back-and-forth vibration.

In the current optomechanical system of a projection device disposed with an actuator, in order to absorb the ineffective light beam generated when the light valve is in the off state, an off-ray heatsink is added between the total reflection prism and the actuator to absorb the ineffective light beam. However, when the heatsink is placed, the back focus of the projection lens will be increased, and it will cost a lot of money to re-open the mold to manufacture a new projection lens before it may be used. If the heatsink is not placed, there will be a problem of light leakage at the image edge.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides an actuating module and a projection device, which may ensure the transmission of an image light beam and prevent an ineffective light beam from entering a projection lens.

Other purposes and advantages of the disclosure may be further understood from the technical features disclosed in the disclosure.

To achieve one or part or all of the above objectives or other objectives, the disclosure provides an actuating module, including a frame, a light-transmitting element, at least one actuator, and a light shielding member. The light-transmitting element is disposed on the frame. A part of at least one actuator is connected to the frame for driving the frame to vibrate. The light shielding member is configured to overlap at least a part of an incident surface, a light emitting surface or one of a combination thereof of the light-transmitting element for reflecting and/or absorbing a light beam.

To achieve one or part or all of the above objectives or other objectives, the disclosure further provides a projection device, including an illumination system, an optomechanical module, and a projection lens. The illumination system is configured to provide an illumination light beam. The optomechanical module includes a light valve and an actuating module. The light valve is disposed on a transmission path of the illumination light beam for converting the illumination light beam into an image light beam and an ineffective light beam. The actuating module is disposed on a transmission path of the image light beam for shifting the transmission path of the image light beam. The actuating module includes a frame, a light-transmitting element, at least one actuator, and a light shielding member. The light-transmitting element is disposed on the frame. A part of at least one actuator is connected to the frame for driving the frame to vibrate. The light shielding member is configured to overlap at least a part of an incident surface, a light emitting surface or one of a combination thereof of the light-transmitting element for reflecting and/or absorbing at least a part of the ineffective light beam. The projection lens is disposed on the transmission path of the image light beam from the optomechanical module for projecting the image light beam out of the projection device.

Based on the above, the embodiment of the disclosure has at least one of the following advantages or functions. In the actuating module and the projection device of the disclosure, the actuating module includes the frame, the light-transmitting element, at least one actuator, and the light shielding member. The light shielding member is configured to overlap at least a part of the incident surface, the light emitting surface or one of a combination thereof of the light-transmitting element for reflecting and/or absorbing the light beam. Therefore, through the configuration of the light shielding member, the transmission of the image light beam may be ensured, and the ineffective light beam may be prevented from entering the projection lens. In this way, the light leakage caused by the ineffective light beam entering the projection lens may be reduced, and the image display effect in the off state may be improved. In addition, existing mass-produced projection lenses may be used without having to re-open the mold to manufacture the lenses. In addition, under the optical structure of the projection lens with a short back focus, the problem of excessive volume caused by the configuration of other elements may be solved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the disclosure.

FIG. 2 is a schematic diagram of an optomechanical module according to an embodiment of the disclosure.

FIG. 3 is a schematic diagram of an actuating module according to an embodiment of the disclosure.

FIG. 4 is a schematic diagram of the actuating module of FIG. 3 and a heat dissipation member according to an embodiment of the disclosure.

FIG. 5 is a schematic top-view diagram of the actuating module and the heat dissipation member of FIG. 4.

FIG. 6 is a diagram of a light energy distribution along a section line A of FIG. 5.

FIG. 7 is a schematic diagram of an optomechanical module according to another embodiment of the disclosure.

FIG. 8 is a schematic diagram of an optomechanical module according to another embodiment of the disclosure.

FIG. 9 is a schematic diagram of an optomechanical module according to another embodiment of the disclosure.

FIG. 10 is a schematic diagram of an optomechanical module according to another embodiment of the disclosure.

FIG. 11 is a schematic diagram of an optomechanical module according to another embodiment of the disclosure.

FIG. 12 is a schematic diagram of an optomechanical module according to another embodiment of the disclosure.

FIG. 13 is a schematic diagram of an optomechanical module according to another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

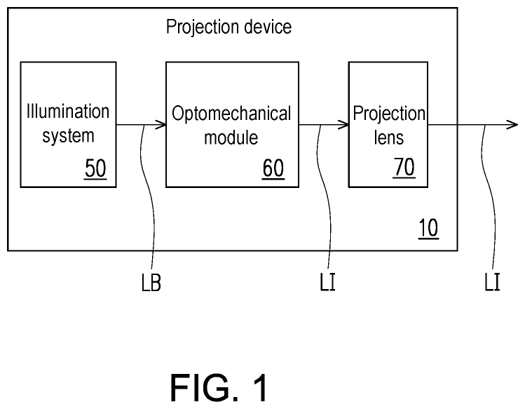

FIG. 1 is a schematic diagram of a projection device according to an embodiment of the disclosure. Please refer to FIG. 1. The embodiment provides a projection device 10 including an illumination system 50, an optomechanical module 60, and a projection lens 70. The illumination system 50 is configured to provide an illumination light beam LB. The optomechanical module 60 is disposed on a transmission path of the illumination light beam LB for converting the illumination light beam LB into an image light beam LI. The projection lens 70 is disposed on a transmission path of the image light beam LI for projecting the image light beam LI out of the projection device 10 to a projection target (not shown), such as a screen or a wall.

The illumination system 50 is configured to provide the illumination light beam LB. For example, in the embodiment, the illumination system 50 includes multiple light emitting elements, a wavelength conversion element, a light uniformizing element, a filter element, and multiple light splitting/combining optics element to provide lights of different wavelengths. The multiple light emitting elements are, for example, light emitting diodes (LED) or laser diodes (LD). However, the disclosure does not limit the type or the form of the illumination system 50 in the projection device 10. Details of the structure and the implementation thereof may be obtained from sufficient teachings, suggestions, and implementation descriptions based on common knowledge in the technical field, so the details are not repeated here.

The optomechanical module 60 includes, for example, multiple prism elements, at least one light valve, and multiple different types of optical elements. The optomechanical module 60 is used for receiving the illumination light beam LB provided by the illumination system 50 and forming the image light beam LI. Details of the implementation will be described in the following paragraphs.

The projection lens 70 includes, for example, a combination of one or more optical lenses having diopters, such as various combinations of non-planar lenses such as planar optical lenses, biconcave lenses, biconvex lenses, concave-convex lenses, convex-concave lenses, plano-convex lenses, and plano-concave lenses. The disclosure does not limit the form and the type of the projection lens 70. In the embodiment, the back focal length of the projection lens 70 is less than 38.5 mm.

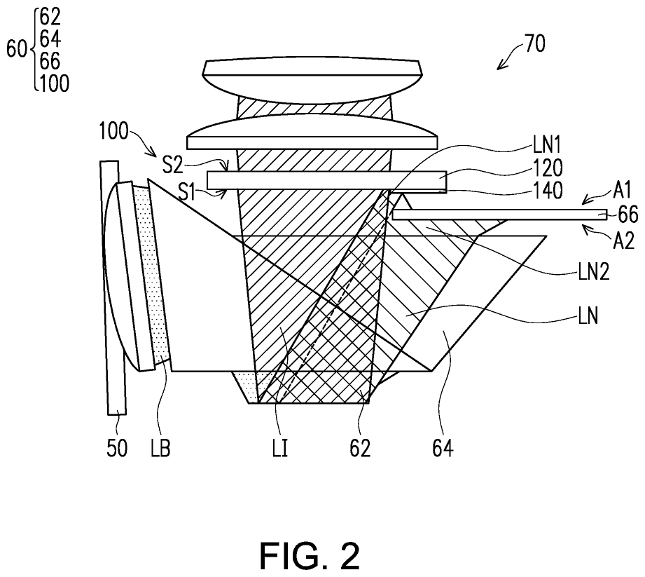

FIG. 2 is a schematic diagram of an optomechanical module according to an embodiment of the disclosure. The optomechanical module 60 of the embodiment may at least be applied to the projection device 10 shown in FIG. 1, so please refer to FIG. 2 for the example. In the embodiment, the optomechanical module 60 includes a light valve 62 and an actuating module 100. The light valve 62 is disposed on the transmission path of the illumination light beam LB for converting the illumination light beam LB into the image light beam LI and an ineffective light beam LN. The projection area of the image light beam LI and the projection area of the ineffective light beam LN are respectively filled with oblique lines of different angles in the corresponding figures. In the embodiment, the light valve 62 is, for example, a reflective light modulator such as a liquid crystal on silicon panel (LCoS panel) or a digital micro-mirror device (DMD). In some embodiments, the light valve 62 may also be a transmission optical modulator such as a transparent liquid crystal panel, an electro-optical modulator, a magneto-optic modulator, or an acousto-optic modulator (AOM). The disclosure does not limit the form and the type of the light valve 62. Specifically, the light valve 62 is configured to convert the illumination light beam LB into the image light beam LI in an on state and convert the illumination light beam LB into the ineffective light beam LN in an off state. The actuating module 100 is disposed on the transmission path of the image light beam LI and is configured to vibrate for shifting the transmission path of the image light beam LI. Specifically, in the embodiment, the optomechanical module 60 further includes a light guiding prism 64 configured to guide the illumination light beam LB from the illumination system 50 to the light valve 62 and guide the image light beam LI from the light valve 62 to the actuating module 100. The light guiding prism 64 is, for example, a total internal reflection prism (TIR prism or RTIR prism).

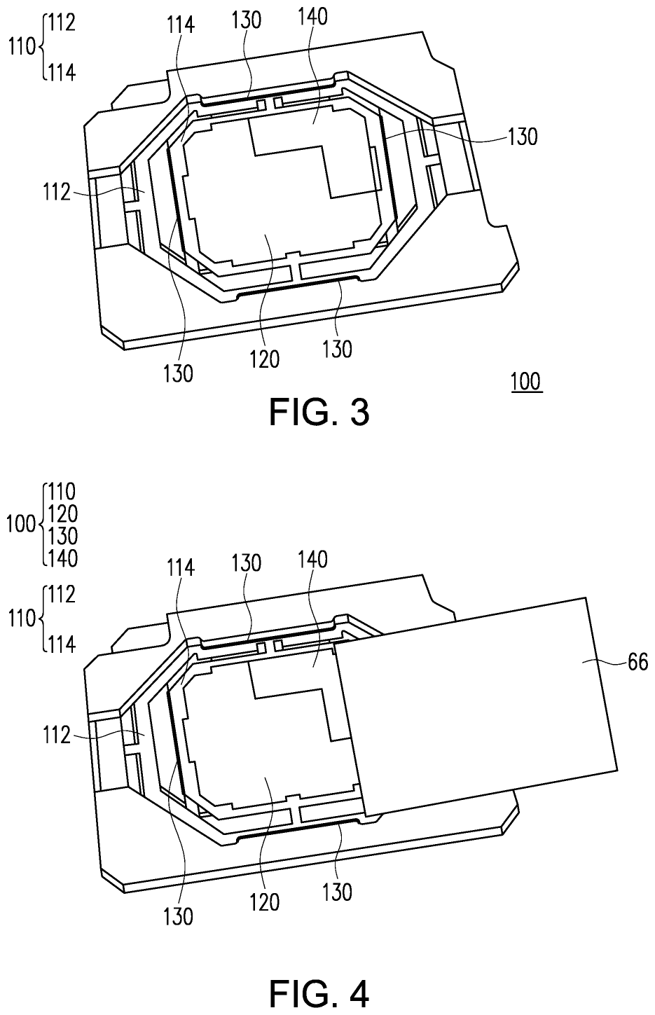

FIG. 3 is a schematic diagram of an actuating module according to an embodiment of the disclosure. The actuating module 100 of the embodiment may be applied to at least the optomechanical module 60 shown in FIG. 2, so please refer to FIG. 3 for the example. The actuating module 100 includes a frame 110, a light-transmitting element 120, at least one actuator 130, and a light shielding member 140. The frame 110 includes, for example, a first frame 112 and a second frame 114 fixed to the casing of the optomechanical module 60. The first frame 112 is used as an outer frame of the frame 110 and is pivotally connected to the casing of the optomechanical module 60 for vibrating relative to the casing. The second frame 114 is pivotally connected to the first frame 112 for vibrating relative to the first frame 112. In other words, the first frame 112 surrounds the second frame 114. The light-transmitting element 120 is disposed in the second frame 114 of the frame 110, and the light-transmitting element 120 is, for example, light-transmitting glass. The number of the at least one actuator 130, for example, is four. Each of the actuators 130 includes at least one magnet and at least one coil. In an embodiment, each magnet of two of the actuators 130 is disposed on the second frame 114 of the frame 110, each coil of the two of the actuators 130 is disposed on the first frame 112 of the frame 110, and each magnet of the other two of the actuators 130 is disposed on the first frame 112 of the frame 110, each coil of the other two of the actuators 130 is disposed on the casing of the optomechanical module 60. The disposition positions of the magnet and the coil are corresponding to each other. The second frame 114 may be caused to vibrate relative to the first frame 112 (e.g., vibrate in a reciprocating manner) by electrification and the first frame 112 may be caused to vibrate relative to the casing (e.g., vibrate in a reciprocating manner) by electrification, and the light-transmitting element 120 may be further driven by the first frame 112 or by the second frame 114 to vibrate (e.g., vibrate in a reciprocating manner) in two axes. It should be noted that the disposition positions of the magnet and the coil may be replaced with each other. That is, each magnet may also be disposed on the first frame 112 of the frame 110, and each coil may be disposed on the second frame 114 of the frame 110. The second frame 114 may vibrate by electrification, but the disclosure is not limited thereto. It should be further explained that the first frame 112 and the second frame 114 may be made of metal or plastic material, and the disclosure is not limited thereto.

The light shielding member 140 is disposed on a transmission path of the ineffective light beam LN and overlaps at least a part of an incident surface S1, a light emitting surface S2 or one of a combination thereof of the light-transmitting element 120 for reflecting and/or absorbing the light beam. In the embodiment, the aforementioned light beam is at least a part of the ineffective light beam LN, so an overlapping direction thereof is the transmission direction of the ineffective light beam LN. The overlapping direction is the arrangement direction of the light-transmitting element 120 and the light shielding member 140. In detail, in the embodiment, the light shielding member 140 includes, for example, a reflective material or a light-absorbing material and may be attached to the incident surface S1 of the light-transmitting element 120 by an attaching method, or formed on the incident surface S1 of the light-transmitting element 120 by coating, and the light shielding member 140 can form an area of an L shape, straight line, ring shape, or irregular-shape on the light-transmitting element 120. In other words, when the light-transmitting element 120 vibrates, the light shielding member 140 is configured to vibrate together according to the frame 110, or the light shielding member 140 vibrates together with the light-transmitting element 120. In another embodiment, the light shielding member 140 may be connected to the first frame 112 of the frame 110, so that there is a distance between the light shielding member 140 and the light-transmitting element 120. Therefore, in the embodiment, the light shielding member 140 will not vibrate together with the light-transmitting element 120.

There is a distance between an orthographic projection of the light shielding member 140 on the light-transmitting element 120 and the imaging range of the image light beam LI on the light-transmitting element 120. That is, the shortest distance between the light shielding member 140 and the image light beam LI is greater than zero. In other words, an orthographic projection of the light shielding member 140 on a light emitting surface (not shown) of the light guiding prism 64 and the image light beam LI do not overlap. Therefore, the transmission of the image light beam LI may be ensured, and the ineffective light beam LN may be prevented from entering the projection lens 70. In this way, through the configuration of the light shielding member 140, the light leakage caused by the ineffective light beam entering the projection lens 70 may be reduced, and the display effect in the off state is improved. In addition, existing mass-produced projection lenses may be used without having to re-open the mold to manufacture the lenses. In addition, under the optical structure of the projection lens 70 with a short back focus, the problem of excessive volume caused by the configuration of other elements may be solved. In the embodiment, at least a part of the ineffective light beam LN reflected or absorbed by the light shielding member 140 is less than or equal to 30% of the entire ineffective light beam LN.

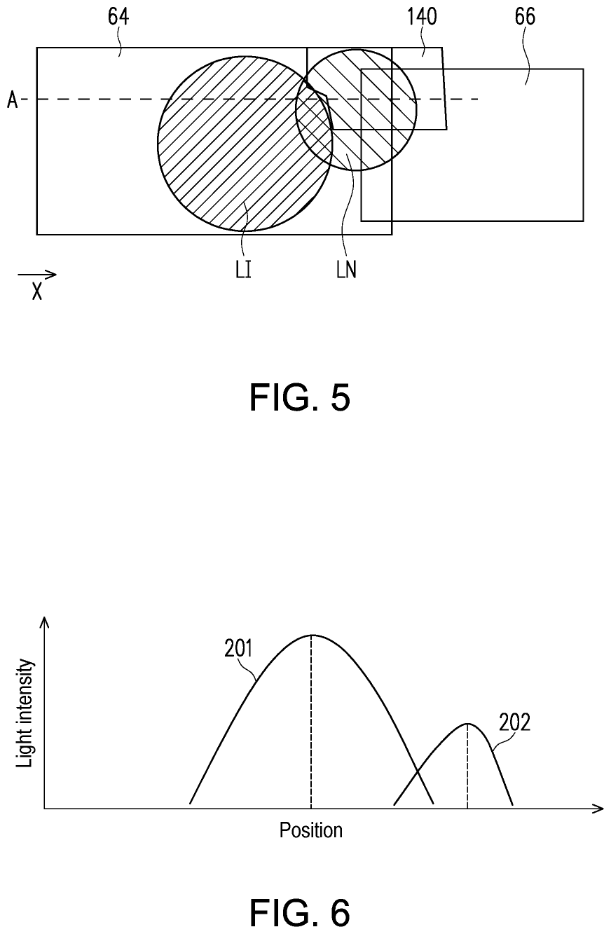

FIG. 4 is a schematic diagram of the actuating module of FIG. 3 and a heat dissipation member according to an embodiment of the disclosure. FIG. 5 is a schematic top-view diagram of the actuating module and the heat dissipation member of FIG. 4. FIG. 6 is a diagram of a light energy distribution along a section line A of FIG. 5. Please refer to FIG. 2 and FIG. 4 to FIG. 6. In FIG. 6, a curve 201 represents the light energy distribution of the image light beam LI at the section line A of FIG. 5, and a curve 202 represents the light energy distribution of the ineffective light beam LN at the section line A of FIG. 5. In the embodiment, the optomechanical module 60 further includes a heat dissipation member 66 disposed between the light guiding prism 64 and the actuating module 100. The thickness of the light shielding member 140 in the transmission direction of the ineffective light beam LN is less than the thickness of the heat dissipation member 66 in the transmission direction of the ineffective light beam LN. The heat dissipation member 66 is disposed on the transmission path of the ineffective light beam LN, and the shortest distance between the heat dissipation member 66 and the image light beam LI is greater than zero. In detail, in the embodiment, along the X axis, the shortest distance between the light shielding member 140 and the image light beam LI is less than the shortest distance between the heat dissipation member 66 and the image light beam LI.

To further define, the heat dissipation member 66 has a first side A1 and a second side A2 opposite to each other. The first side A1 faces the light shielding member 140. The ineffective light beam LN includes a first ineffective light beam LN1 and a second ineffective light beam LN2. The first ineffective light beam LN1 is transmitted from the light valve 62 to the light shielding member 140, and the second ineffective light beam LN2 is transmitted from the light valve 62 to the second side A2 of the heat dissipation member 66. The first ineffective light beam LN1 is reflected by the light shielding member 140 and transmitted to the first side A1 of the heat dissipation member 66. In this way, through the configuration and the matching of the light shielding member 140 and the heat dissipation member 66, the ineffective light beam LN may be effectively blocked, thereby reducing the light leakage caused by the ineffective light beam LN entering the projection lens 70 and improving the image display effect in the off state. In addition, existing mass-produced projection lenses may be used without having to re-open the mold to manufacture the lenses. In addition, under the optical structure of the projection lens 70 with a short back focus, the problem of excessive volume caused by the configuration of other elements may be solved.

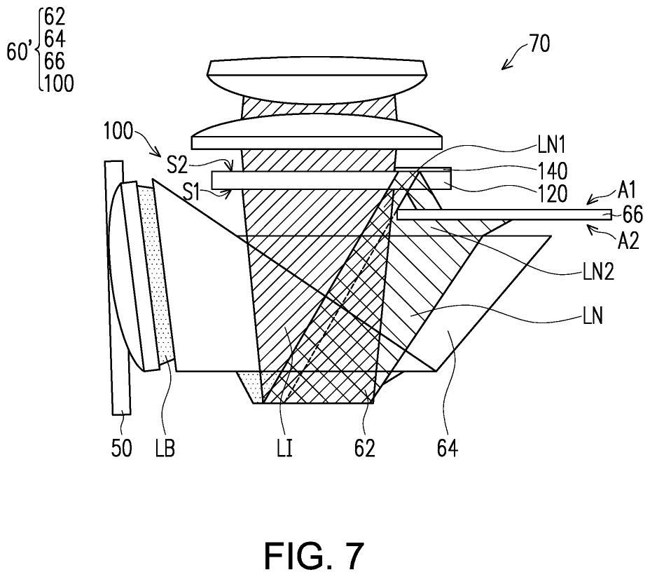

FIG. 7 is a schematic diagram of an optomechanical module according to another embodiment of the disclosure. Please refer to FIG. 7. An optomechanical module 60′ shown in the embodiment is similar to the optomechanical module 60 shown in FIG. 2. The difference between the two is that the light shielding member 140 of the actuating module 100 in FIG. 7 is attached to the light emitting surface S2 of the light-transmitting element 120, or formed on the light emitting surface S2 of the light-transmitting element 120 by coating. In other words, the light-transmitting element 120 in FIG. 7 is not disposed on the incident surface S1 of the light-transmitting element 120. In addition, the light shielding member 140 may include, for example, a reflective material or a light-absorbing material, and may also form an area of an L shape, straight line, ring shape, or irregular-shape on the light-transmitting element 120.

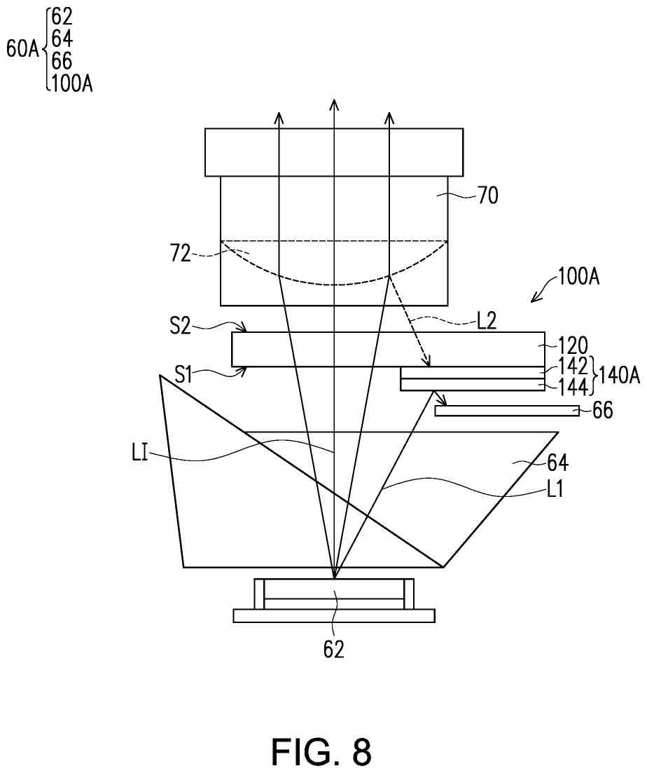

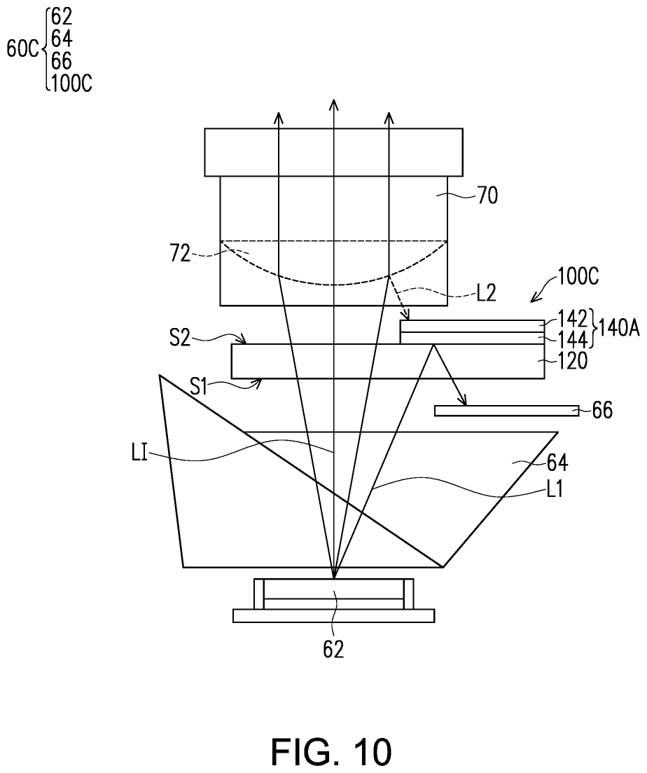

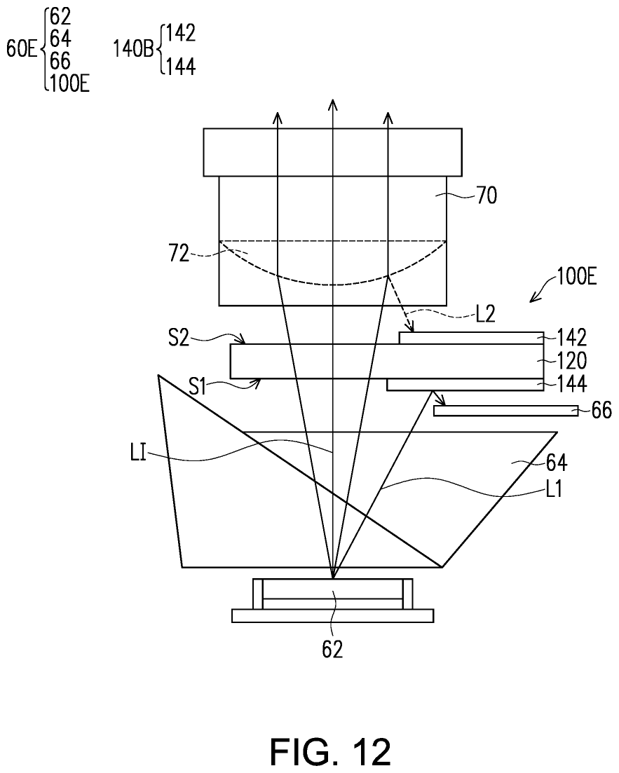

FIG. 8 is a schematic diagram of an optomechanical module according to another embodiment of the disclosure. Some optical elements are omitted in the drawing. Please refer to FIG. 8. The embodiment provides an optomechanical module 60A, which is similar to the optomechanical module 60 shown in FIG. 2. The only difference between the two is that a light shielding member 140A of the actuating module 100A in FIG. 8 includes a light absorbing layer 142 and a reflective layer 144. The light absorbing layer 142 and the reflective layer 144 in the embodiment are similar to the light-absorbing material and the reflective material used in the light shielding member in the embodiment of FIG. 2. The reflectivity of the light absorbing layer 142 in the embodiment is less than 5%. The light absorbing layer 142 is disposed on the incident surface S1 of the light-transmitting element 120, and the light absorbing layer 142 is located between the incident surface S1 of the light-transmitting element 120 and the reflective layer 144. Similar to the configuration of the light shielding member 140 of the above-mentioned embodiment, the orthographic projection of the light shielding member 140 on the light emitting surface S2 of the light-transmitting element 120 does not overlap the light spot range formed by the image light beam LI on the light emitting surface S2 of the light-transmitting element 120. It should be noted that the light absorbing layer 142 may be disposed on the incident surface S1 by coating or attaching, and the reflective layer 144 may be disposed on the light absorbing layer 142 by coating or attaching. In a normal direction of the incident surface S1 (not shown), the orthographic projection of the light absorbing layer 142 on the light emitting surface S2 overlaps the orthographic projection of the reflective layer 144 on the light emitting surface S2. The actuating module 100A has a first side and a second side that are opposite to each other. The incident surface S1 of the light-transmitting element 120 faces the first side of the actuating module 100A. The light emitting surface S2 of the light-transmitting element 120 faces the second side of the actuating module 100A. The reflective layer 144 is configured to reflect a first light beam L1 from the first side. The light absorbing layer 142 is configured to absorb the second light beam L2 from the second side. The first light beam L1 is the first ineffective light beam LN1 (as shown in FIG. 2), and the second light beam L2 is a part of the image light beam LI reflected by a lens 72 of the projection lens 70. It should be noted that the difference between FIG. 2 and FIG. 8 lies in the light shielding member 140A. However, in order to clearly show the disposition positions of the light absorbing layer 142 and the reflective layer 144 of the light shielding member 140A in FIG. 8, further adjustments are made to the drawing scale and/or the drawing method of other elements. FIG. 10 and FIG. 12 are also drawn with reference to FIG. 8.

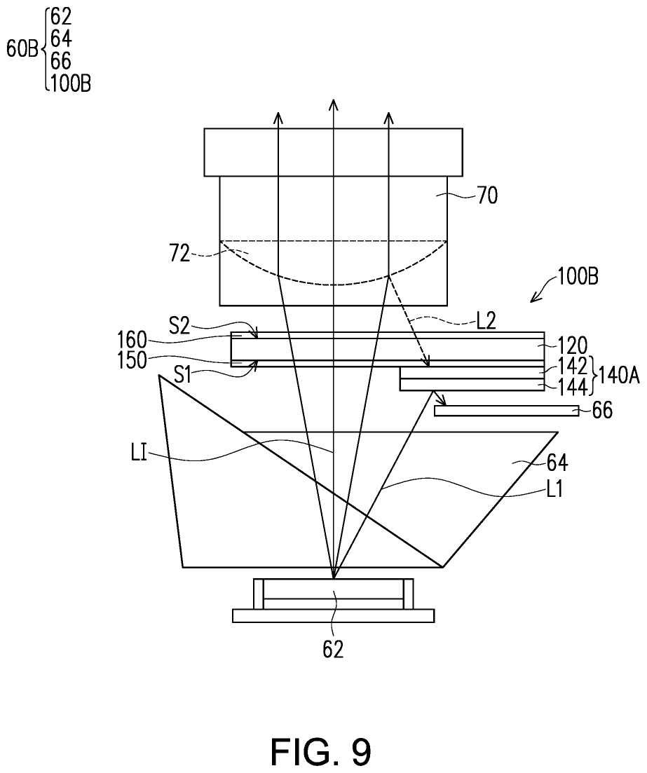

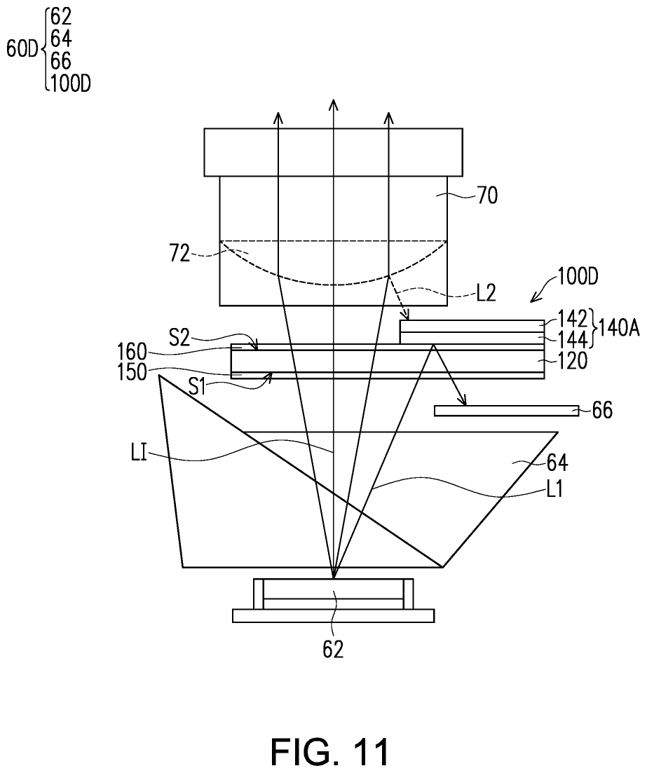

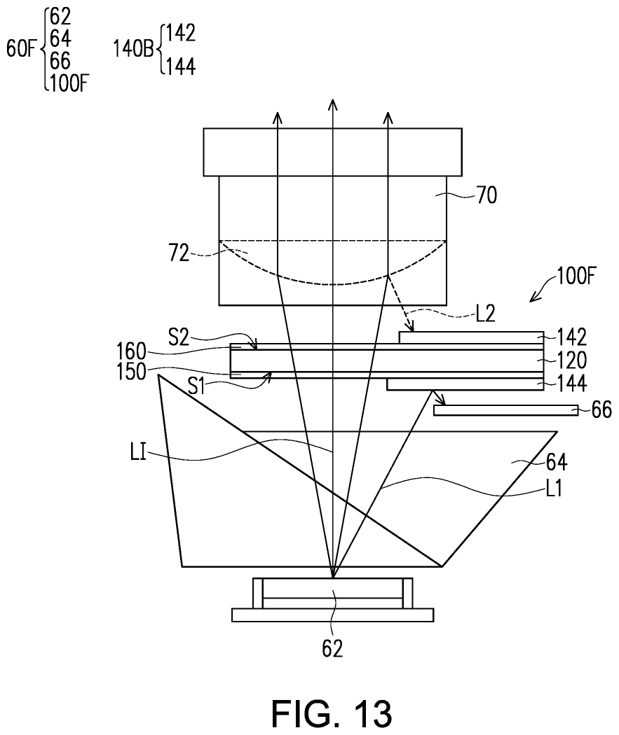

FIG. 9 is a schematic diagram of an optomechanical module according to another embodiment of the disclosure. Please refer to FIG. 9. The embodiment provides an optomechanical module 60B, which is similar to the optomechanical module 60A shown in FIG. 8. The only difference between the two is that an actuating module 100B in this embodiment further includes a first anti-reflective layer 150 and a second anti-reflective layer 160. The first anti-reflective layer 150 is disposed on the incident surface S1 of the light-transmitting element 120, and the second anti-reflective layer 160 is disposed on the light emitting surface S2 of the light-transmitting element 120. In addition, the first anti-reflective layer 150 is located between the light absorbing layer 142 and the incident surface S1 of the light-transmitting element 120, and the light absorbing layer 142 is located between the reflective layer 144 and the first anti-reflective layer 150. The light absorbing layer 142 may be disposed on the first anti-reflective layer 150 by coating or attaching, and the reflective layer 144 may be disposed on the light absorbing layer 142 by coating or attaching. In this way, the light beam may be prevented from being transmitted to the incident surface S1 and the light emitting surface S2 of the light-transmitting element 120 to generate reflected light, thereby improving the optical effect of the actuating module 100B. It should be noted that the difference between FIG. 2 and FIG. 9 lies in the configuration of the light shielding member 140A, the first anti-reflective layer 150, and the second anti-reflective layer 160. However, in order to clearly present the placement positions of the light absorbing layer 142 and the reflective layer 144 of the light shielding member 140A in FIG. 9, and to clearly present the placement positions of the first anti-reflective layer 150 and the second anti-reflective layer 160, further adjustments are made to the drawing scale and/or drawing method of other elements. FIG. 11 and FIG. 13 are also drawn with reference to FIG. 9.

Regarding FIG. 9, it should be further explained that the first anti-reflective layer 150 may be disposed on the entire incident surface S1, or may be disposed on a part of the incident surface S1, and the second anti-reflective layer 160 may be disposed on the entire light emitting surface S2, or may be disposed on a part of the light emitting surface S2. In addition, the first anti-reflective layer 150 and the second anti-reflective layer 160 may be disposed on the incident surface S1 and the light emitting surface S2 of the light-transmitting element 120 respectively by coating or attaching. In addition, in FIG. 11 and FIG. 13, the range in which the first anti-reflective layer 150 and the second anti-reflective layer 160 are disposed on the surface of the light-transmitting element 120 and the manner in which they are disposed on the surface of the light-transmitting element 120 are the same as the technical features mentioned in this paragraph, and therefore will not be repeated in the subsequent relevant paragraphs.

FIG. 10 is a schematic diagram of an optomechanical module according to another embodiment of the disclosure. Please refer to FIG. 10. The embodiment provides an optomechanical module 60C, which is similar to the optomechanical module 60A shown in FIG. 8. The only difference between the two is that the light shielding member 140A of an actuating module 100C in FIG. 10 is disposed on the light emitting surface S2 of the light-transmitting element 120, and the reflective layer 144 of the light shielding member 140A is located between the light emitting surface S2 of the light-transmitting element 120 and the light absorbing layer 142. It should be noted that the light absorbing layer 142 may be disposed on the reflective layer 144 by coating or attaching, and the reflective layer 144 may be disposed on the light emitting surface S2 by coating or attaching.

FIG. 11 is a schematic diagram of an optomechanical module according to another embodiment of the disclosure. Please refer to FIG. 11. The embodiment provides an optomechanical module 60D, which is similar to the optomechanical module 60C shown in FIG. 10. The only difference between the two is that an actuating module 100D in FIG. 11 further includes the first anti-reflective layer 150 and the second anti-reflective layer 160. The first anti-reflective layer 150 is disposed on the incident surface S1 of the light-transmitting element 120, and the second anti-reflective layer 160 is disposed on the light emitting surface S2 of the light-transmitting element 120. In addition, the second anti-reflective layer 160 is located between the reflective layer 144 and the light emitting surface S2 of the light-transmitting element 120, and the reflective layer 144 is located between the second anti-reflective layer 160 and the light absorbing layer 142. The light absorbing layer 142 may be disposed on the reflective layer 144 by coating or attaching, and the reflective layer 144 may be disposed on the second anti-reflective layer 160 by coating or attaching. In this way, the light beam may be prevented from being transmitted to the incident surface S1 and the light emitting surface S2 of the light-transmitting element 120 to generate reflected light, thereby improving the optical effect of the actuating module 100D.

FIG. 12 is a schematic diagram of an optomechanical module according to another embodiment of the disclosure. Please refer to FIG. 12. The embodiment provides an optomechanical module 60E, which is similar to the optomechanical module 60A shown in FIG. 8. The only difference between the two is that the light absorbing layer 142 of a light shielding member 140B of an actuating module 100E in FIG. 12 is disposed on the light emitting surface S2 of the light-transmitting element 120, and the reflective layer 144 is disposed on the incident surface S1 of the light-transmitting element 120. The light absorbing layer 142 may be disposed on the light emitting surface S2 by coating or attaching, and the reflective layer 144 may be disposed on the incident surface S1 by coating or attaching. In addition, in the embodiment, in the normal direction of the incident surface S1 of the light-transmitting element 120, the orthographic projection area of the reflective layer 144 on the incident surface S1 is greater than the orthographic projection area of the light absorbing layer 142 on the incident surface S1. In this way, the first ineffective light beam (i.e., the first light beam L1) from the light valve 62 may be prevented from being transmitted to the light absorbing layer 142.

FIG. 13 is a schematic diagram of an optomechanical module according to another embodiment of the disclosure. Please refer to FIG. 13. The embodiment provides an optomechanical module 60F, which is similar to the optomechanical module 60E shown in FIG. 12. The only difference between the two is that an actuating module 100F in FIG. 13 further includes the first anti-reflective layer 150 and the second anti-reflective layer 160. The first anti-reflective layer 150 is disposed on the incident surface S1 of the light-transmitting element 120, and the second anti-reflective layer 160 is disposed on the light emitting surface S2 of the light-transmitting element 120. In addition, the first anti-reflective layer 150 is located between the reflective layer 144 and the incident surface S1 of the light-transmitting element 120, and the second anti-reflective layer 160 is located between the light absorbing layer 142 and the light emitting surface S2 of the light-transmitting element 120. The light absorbing layer 142 may be disposed on the second anti-reflective layer 160 by coating or attaching, and the reflective layer 144 may be disposed on the first anti-reflective layer 150 by coating or attaching. In this way, the light beam may be prevented from being transmitted to the incident surface S1 and the light emitting surface S2 of the light-transmitting element 120 to generate reflected light, thereby improving the optical effect of the actuating module 100F.

To sum up, in the actuating module and the projection device of the disclosure, the actuating module includes the frame, the light-transmitting element, at least one actuator, and the light shielding member. The light shielding member is configured to overlap at least a part of the incident surface, the light emitting surface or one of a combination thereof of the light-transmitting element for reflecting and/or absorbing the light beam. Therefore, through the configuration of the light shielding member, the transmission of the image light beam may be ensured, and the ineffective light beam may be prevented from entering the projection lens. In this way, the light leakage caused by the ineffective light beam entering the projection lens may be reduced, and the image display effect in the off state may be improved. In addition, existing mass-produced projection lenses may be used without having to re-open the mold to manufacture the lenses. In addition, under the optical structure of the projection lens with a short back focus, the problem of excessive volume caused by the configuration of other elements may be solved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An actuating module, comprising a frame, a light-transmitting element, at least one actuator, and a light shielding member, wherein:
the light-transmitting element is disposed on the frame;
a part of the at least one actuator is connected to the frame for driving the frame to vibrate; and
the light shielding member overlaps at least a part of an incident surface, a light emitting surface or one of a combination thereof of the light-transmitting element for reflecting and/or absorbing a light beam.

2. The actuating module according to claim 1, wherein the light shielding member comprises a light absorbing layer and a reflective layer, the incident surface faces a first side of the actuating module, the light emitting surface faces a second side of the actuating module, the reflective layer is configured to reflect a first light beam from the first side, and the light absorbing layer is configured to absorb a second light beam from the second side.

3. The actuating module according to claim 2, wherein in a normal direction of the incident surface, an orthographic projection of the light absorbing layer overlaps an orthographic projection of the reflective layer.

4. The actuating module according to claim 2, wherein the light absorbing layer is disposed on the incident surface of the light-transmitting element, and the light absorbing layer is located between the incident surface and the reflective layer.

5. The actuating module according to claim 2, wherein the reflective layer is disposed on the light emitting surface of the light-transmitting element, and the reflective layer is located between the light emitting surface and the light absorbing layer.

6. The actuating module according to claim 2, wherein the light absorbing layer is disposed on the light emitting surface of the light-transmitting element, and the reflective layer is disposed on the incident surface of the light-transmitting element.

7. The actuating module according to claim 6, wherein in a normal direction of the incident surface, an orthographic projection area of the reflective layer is greater than an orthographic projection area of the light absorbing layer.

8. The actuating module according to claim 2, further comprising a first anti-reflective layer and a second anti-reflective layer, wherein the first anti-reflective layer is disposed on the incident surface, and the second anti-reflective layer is disposed on the light emitting surface.

9. The actuating module according to claim 8, wherein the first anti-reflective layer is located between the light absorbing layer and the incident surface, and the light absorbing layer is located between the reflective layer and the first anti-reflective layer.

10. The actuating module according to claim 8, wherein the second anti-reflective layer is located between the reflective layer and the light emitting surface, and the reflective layer is located between the second anti-reflective layer and the light absorbing layer.

11. The actuating module according to claim 8, wherein the first anti-reflective layer is located between the reflective layer and the incident surface, and the second anti-reflective layer is located between the light absorbing layer and the light emitting surface.

12. The actuating module according to claim 11, wherein in a normal direction of the incident surface, an orthographic projection area of the reflective layer is greater than an orthographic projection area of the light absorbing layer.

13. The actuating module according to claim 1, wherein the light shielding member is formed on the light-transmitting element by coating.

14. The actuating module according to claim 1, wherein the light shielding member is attached to the light-transmitting element.

15. The actuating module according to claim 1, wherein the light shielding member is connected to the frame, and there is a distance between the light shielding member and the light-transmitting element.

16. The actuating module according to claim 1, wherein the light shielding member is configured to vibrate together according to the frame.

17. A projection device, comprising an illumination system, an optomechanical module, and a projection lens, wherein:
the illumination system is configured to provide an illumination light beam;
the optomechanical module comprises a light valve and an actuating module, wherein:
the light valve is disposed on a transmission path of the illumination light beam for converting the illumination light beam into an image light beam and an ineffective light beam; and
the actuating module is disposed on a transmission path of the image light beam to shift the transmission path of the image light beam, and the actuating module comprises a frame, a light-transmitting element, at least one actuator, and a light shielding member, wherein:
the light-transmitting element is fixed on the frame;
the at least one actuator is connected to the frame for driving the frame to vibrate; and
the light shielding member overlaps at least a part of an incident surface, a light emitting surface or one of a combination thereof of the light-transmitting element for reflecting and/or absorbing at least a part of the ineffective light beam; and
the projection lens is disposed on the transmission path of the image light beam from the optomechanical module for projecting the image light beam out of the projection device.

18. The projection device according to claim 17, wherein the light shielding member comprises a light absorbing layer and a reflective layer, the incident surface faces a first side of the actuating module, the light emitting surface faces a second side of the actuating module, the reflective layer is configured to reflect a first light beam from the first side, and the light absorbing layer is configured to absorb a second light beam from the second side.

19. The projection device according to claim 18, wherein in a normal direction of the incident surface, an orthographic projection of the light absorbing layer overlaps an orthographic projection of the reflective layer.

20. The projection device according to claim 18, wherein the light absorbing layer is disposed on the incident surface of the light-transmitting element, and the light absorbing layer is located between the incident surface and the reflective layer.

21. The projection device according to claim 18, wherein the reflective layer is disposed on the light emitting surface of the light-transmitting element, and the reflective layer is located between the light emitting surface and the light absorbing layer.

22. The projection device according to claim 18, wherein the light absorbing layer is disposed on the light emitting surface of the light-transmitting element, and the reflective layer is disposed on the incident surface of the light-transmitting element.

23. The projection device according to claim 22, wherein in a normal direction of the incident surface, an orthographic projection area of the reflective layer is greater than an orthographic projection area of the light absorbing layer.

24. The projection device according to claim 18, further comprising a first anti-reflective layer and a second anti-reflective layer, the first anti-reflective layer is disposed on the incident surface, and the second anti-reflective layer is disposed on the light emitting surface.

25. The projection device according to claim 24, wherein the first anti-reflective layer is located between the light absorbing layer and the incident surface, and the light absorbing layer is located between the reflective layer and the first anti-reflective layer.

26. The projection device according to claim 24, wherein the second anti-reflective layer is located between the reflective layer and the light emitting surface, and the reflective layer is located between the second anti-reflective layer and the light absorbing layer.

27. The projection device according to claim 24, wherein the first anti-reflective layer is located between the reflective layer and the incident surface, and the second anti-reflective layer is located between the light absorbing layer and the light emitting surface.

28. The projection device according to claim 27, wherein in a normal direction of the incident surface, an orthographic projection area of the reflective layer is greater than the orthographic projection area of the light absorbing layer.

29. The projection device according to claim 17, wherein the light shielding member is formed on the light-transmitting element by coating.

30. The projection device according to claim 17, wherein the light shielding member is attached to the light-transmitting element.

31. The projection device according to claim 17, wherein the light shielding member is connected to the frame, and there is a distance between the light shielding member and the light-transmitting element.

32. The projection device according to claim 17, wherein the light-transmitting element is disposed on the transmission path of the image light beam, and there is a distance between an orthographic projection of the light shielding member on the light-transmitting element and an imaging range of the image light beam on the light-transmitting element.

33. The projection device according to claim 17, wherein the light shielding member is configured to vibrate together according to the frame.

34. The projection device according to claim 17, wherein the light shielding member is disposed on a transmission path of the ineffective light beam, and a shortest distance between the light shielding member and the image light beam is greater than zero.

35. The projection device according to claim 17, wherein the optomechanical module further comprises a light guiding prism configured to guide the illumination light beam from the illumination system to the light valve and guide the image light beam from the light valve to the actuating module.

36. The projection device according to claim 35, wherein an orthographic projection of the light shielding member on a light emitting surface of the light guiding prism and the image light beam do not overlap.

37. The projection device according to claim 35, wherein the optomechanical module further comprises a heat dissipation member disposed between the light guiding prism and the actuating module, the heat dissipation member is disposed on a transmission path of the ineffective light beam, and a shortest distance between the heat dissipation member and the image light beam is greater than zero.

38. The projection device according to claim 37, wherein a thickness of the light shielding member in a transmission direction of the ineffective light beam is less than a thickness of the heat dissipation member in a transmission direction of the ineffective light beam.

39. The projection device according to claim 37, wherein a shortest distance between the light shielding member and the image light beam is less than the shortest distance between the heat dissipation member and the image light beam.

40. The projection device according to claim 37, wherein the heat dissipation member has a first side and a second side opposite to each other, the first side of the heat dissipation member faces the light shielding member, the ineffective light beam comprises a first ineffective light beam and a second ineffective light beam, the first ineffective light beam is transmitted to the light shielding member, and the second ineffective light beam is transmitted to the second side of the heat dissipation member.

41. The projection device according to claim 40, wherein the first ineffective light beam is reflected by the light shielding member and transmitted to the first side of the heat dissipation member.

42. The projection device according to claim 17, wherein the light shielding member reflects or absorbs at least a part of the ineffective light beam which is less than or equal to 30% of the entire ineffective light beam.

43. The projection device according to claim 17, wherein a back focal length of the projection lens is less than 38.5 mm.
